(19) United States
(12) Patent Application Publication
(10) Pub. No.: US 2021/0154678 A1
(43) Pub. Date: May 27, 2021

(54) HANDLING MACHINE FOR BEVERAGE CONTAINERS AND METHOD FOR HANDLING BEVERAGE CONTAINERS

(71) Applicant: Lars Bruun, Filipstad (SE)

(72) Inventor: Lars Bruun, Filipstad (SE)

(21) Appl. No.: 17/262,841

(22) PCT Filed: Jun. 5, 2019
(86) PCT No.: PCT/EP2019/064619

§ 371 Date: Jan. 25, 2021

(30) Foreign Application Priority Data
Aug. 14, 2018 (SE) 1850979-4
Sep. 26, 2018 (SE) 1851146-9

(51) Int. Cl. B02C 18/22; B02C 18/14; B02C 18/00

(52) U.S. Cl. CPC B02C 18/2241; B02C 18/0084; B02C 18/146

(57) ABSTRACT

The invention relates to a method for handling of containers (9) and a handling machine for containers, comprising an inlet arrangement (8), an infeed arrangement (2), a compressing arrangement (20, 21), a cutting arrangement (4, 6) and an outlet arrangement (7), wherein empty containers are compacted. In one embodiment containers are also handled to at least partly be provided in shredded form in the outlet arrangement (7), wherein said cutting arrangement (4, 6) comprises a first cutting unit (4) arranged to cut a container (9) into a plurality of longitudinal, parallel stripes and preferably a second cutting unit (6) arranged to cut transversally in relation to said first cutting unit (4), whereby said longish strips will be cut into a plurality of shredded pieces.

### TECHNICAL FIELD

This invention relates to a handling machine for containers, comprising an inlet arrangement, an infeed arrangement, a compressing arrangement, a compacting arrangement and an outlet arrangement, wherein empty containers are handled to be provided in compacted form in the outlet arrangement.

### BACKGROUND

More and more of containers used need to be recycled and therefor handled in an environmentally friendly manner, which generally is also in a cost-efficient manner. In that regard the volume that is occupied by the recycled products has great influence. If it takes up low volume, e.g. is in a form of high density, it may provide significant advantages regarding both storage and transportation. There exists a great number of machines for handling of containers, especially containers for beverages, e.g. PET bottles and aluminium cans. The known handling machines provide a relatively limited reduction of the volume of containers. For instance, some handling machines merely, compact cans containing 50 centilitres to about 20 to 23 centilitres, which for aluminium implies a density of merely about 0.2, whereas aluminium in solid form has a density of 2.7. As a consequence, about 90% of the space during storage and transportation is air.

Beside an ineffective transportation there is also a problem related to the size of storage locally, especially big cities where available space is limited and therefore also costly.

Accordingly, there is a need for a more effective handling of containers that provides for better density of the stored and transported containers after having been handled by handling machines. These kind of handling machines are often provided for in each grocery store and also for grocery stores available space is limited and therefor costly.

Hence also in relation to the size of the handling machine there is a desire that less space is needed for the installation of such a machine.

From EP 1620252, JP 2001138327 and JP 2013075972 there are known handling machines having as an object to provide for a more compact handling of containers. The handling machines comprise a housing with a fill opening and an outlet in addition to a cutting and pressing unit disposed in said housing. The cutting and pressing unit includes rollers whose axis of rotation are arranged at a distance from each other wherein each roller comprises several discs successively following each other in an alternate manner to be off-set and partially overlap with each other, thereby forming cutting discs, that will enable a handled container to be stored and transported in a more compact configuration than traditional machines.

However, also the described handling machine suffers from inefficient compacting seen in relation to the potential compaction that would be possible having regard to the actual density of the material. Furthermore, these machines require relatively large power input and are also relatively large in size.

### SUMMARY OF THE INVENTION

It is an object of the invention to minimize the above-mentioned problems, which is achieved by means of handling machine according to claim 1 and also a method according to claim 11.

Thanks to the novel handling machine there is achieved an efficient compacting of the containers resulting in compacted parts that may be compactly stored and transported, thereby saving a lot of space to be available for better use. An important advantage of the invention is the use of a cutting arrangement that delivers stripes being substantially flat thanks to the use of relatively thin knife blades interacting with a relatively wide support surface and also enables relatively limited input of power, i.e. may facilitate significantly less energy input than traditional machines.

In a preferred embodiment also shredding of the compacted units is performed resulting in shredded pieces that may be even more compactly stored and transported, thereby saving further space to be available for better use.

### BRIEF DESCRIPTION OF THE FIGURES

The invention will be described in more detail in the following with reference to the accompanying drawings, which for the purpose of exemplification illustrate embodiments of the invention.

FIG. 1 shows a schematic side view of a first embodiment of a machine according to the invention in accordance with the preferred embodiment including both compacting and shredding of containers,

FIG. 2 shows a schematic view from behind of the machine in FIG. 1,

FIGS. 3 and 4 show a view from above and a side view, respectively of a first embodiment of a support device for a machine according to the invention,

FIGS. 5 and 6 show a view from above and a side view, respectively of a preferred embodiment of a guide plate for a machine according to the invention,

FIG. 7 shows a schematic side view of a first embodiment of a cutting arrangement according to the invention, together with the first support device and the preferred guide plate.

FIG. 8 shows a schematic view from behind partly in cross-section A-A as indicated in FIG. 7,

FIG. 9 shows a partial side view of a compacting arrangement according to a further embodiment of the support device according to the invention,

FIG. 10 shows a schematic view along cross-section X-X as indicated in FIG. 9,

FIG. 11 shows a schematic view from the side of a preferred embodiment of a machine according to the invention,

FIG. 12 shows a schematic view from the back of the machine in FIG. 11,

FIG. 13 shows a side view, partly in cross section, of a preferred embodiment of a cutting roll according to the invention,

FIG. 14 shows a view of a preferred embodiment of divided knife. i.e. a knife element, according to the invention,

FIGS. 15 and 16 show a front view and a side view, respectively of a preferred embodiment of a collection arrangement according to the invention,

### DETAILED DESCRIPTION

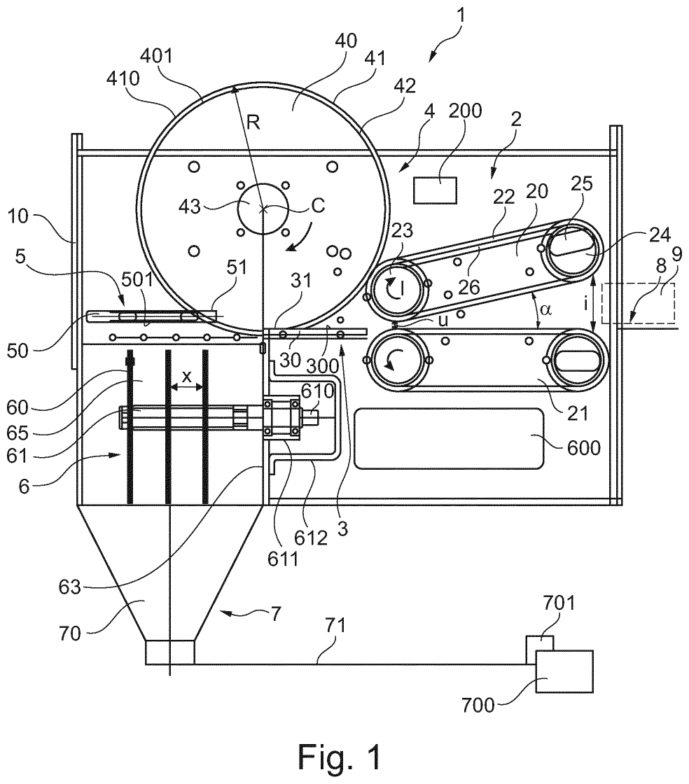

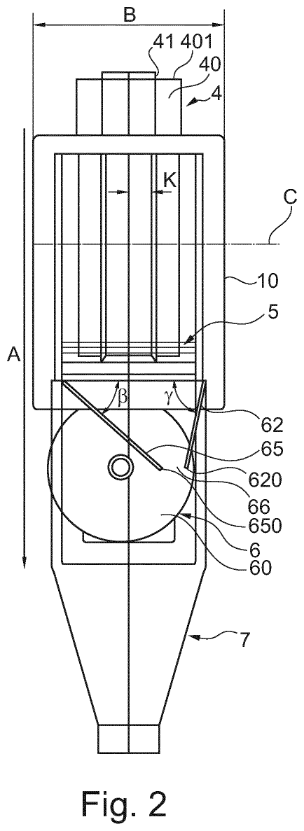

In FIGS. 1 and 2 there are schematically shown a handling machine 1 in accordance with a preferred embodiment of the invention, including both compacting and shredding. The handling machine 1 comprises a plurality of units that sequentially handles one beverage package at a time, e.g. aluminium cans, to finally have it in the form of shredded foils that may be stored and transported in a significantly more compact manner than is possible with machines for handling of beverage packages of today. Further, the design may provide a very compact handling machine 1, occupying less than 0.05 m³ (0.6×0.4×0.0.2 m), which may be an important factor regarding facilities (grocery stores, etc) where the machine may be needed.

In a first unit 8 the containers are stored to provide a buffer for filling of one container 9 at a time into an infeed and compressing unit 2. In the infeed and compressing unit 2 the containers are compressed along the length axis to form a generally flat object having a thickness of about 5-20% of its original diameter. The compressing and infeed unit 2 feeds the container 9 onto a support plate 3 which supports the container 9 to securely be supplied to a first cutting unit 4. The first cutting unit 4 preferably compacts the containers further and simultaneously cuts the container 9 into a plurality of longitudinal, parallel stripes. A guide plate 5 controls that the stripes are securely removed from the first cutting unit 4 and once freed from the first cutting unit 4 the foils will fall downwards into a second cutting unit 6, where each longish foil will be cut into a plurality of shredded pieces. Finally, the shredded pieces will be guided in a removal unit 7 and transported away from the handling machine 1 to a storage unit 700.

Accordingly, the handling machine 1 in successive steps handles a container 9 to end up in shredded pieces that will take up very little space in a storage unit 700.

The buffer unit 8 may preferably be in the form of a tube formed device that may feed one container 9 at a time into the infeed and compressing unit 2. The feeding may preferably be provided by having a plurality of containers 9 in a row and by applying pressure onto the containers in the row via each other, e.g. pressing end to end, to thereby safely supply containers continuously to the infeed and compressing unit 2. It is evident for the skilled person that the buffer unit 8 may include various devices and use various principles in order to safeguard continuous supply of containers 9 into the infeed and compressing unit 2 and that the above described exemplified principle does in no way limit the scope of protection regarding the actual handling machine 1.

The infeed and compressing unit 2 comprise two conveyor units 20, 21. In the preferred embodiment to conveyor units 20, 21 comprises two identical chain feeders, comprising a dented pulling wheel 23 with a plurality of parallel dented rings and a plurality of rows of a of endless chains 22 that at the other end are supported by a non-driving dented wheel 24. The two conveyors 20, 21 are arranged with an angle α in relation to their extension from centre to centre of their dented wheels 23, 24, which provides a relatively large opening i at the entrance of the in-feed and compressing unit 2 and a relatively small distance U at the outlet 25 there from. Preferably the angle α is in the range of 10 to 20°, more preferred 16° or less, and has an entrance I that is larger than the standard diameter of a container and an outlet 25 having a passage U that may be about 5-8 millimetres. (3-15 millimetres). The in feed and compressing unit 2 pushes the compressed container 9 on to a support plate 3.

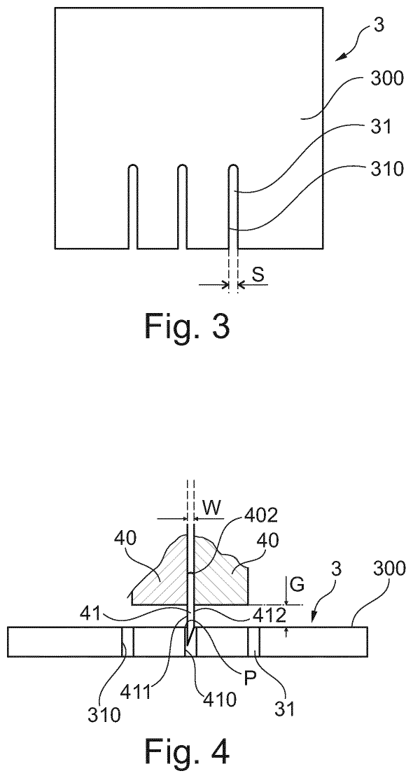

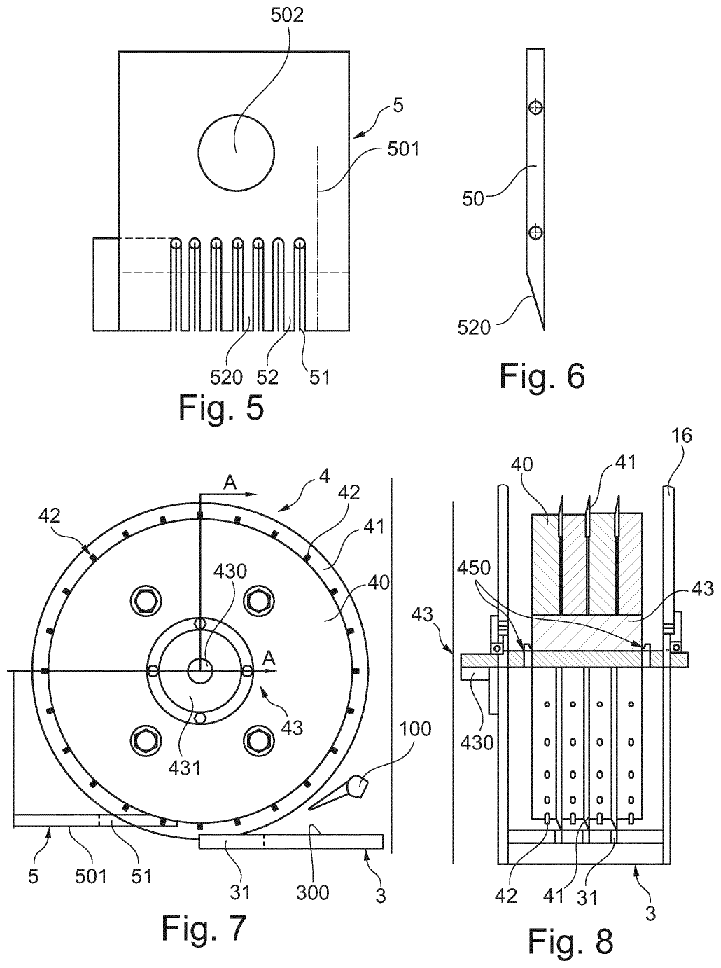

As best shown in FIGS. 3 and 4 the support plate 3 is generally formed of a flat rigid plate body 30 having grooves 31 arranged at the far end, seen in the direction of feeding of the containers 9. As can be seen in FIG. 3 the grooves 31 are arranged in parallel in the far end of the support plate 3. Each groove 31 matches a knife blade 41, e.g. three, arranged on the first cutting unit 4, as will be described in more detail below.

The first cutting arrangement 4 comprises a plurality of discs 40 fixed to each other and arranged on a rotating shaft 43. At the periphery, between each disc 40 there is provided an annular knife 41, preferably in the form of a separate knife blade, having an outer cutting knife edge 410, i.e. presenting a cutting edge that is formed by angled sides that converge into the edge. Hence, each side has an angle in relation to the support plane 300 that is larger than 0°, preferably larger than 10° and more preferred larger than 45°. In the preferred embodiment the knife edge 410 is not totally sharp, but has a substantially flat peripheral surface of about 0.1-0.3 mm, to improve durability of the knife edge 410.

At the outer peripheral surface 401 of the disc 40 there may be arranged feeding members 42 (see FIGS. 1, 7 and 8) that will grab into the container 9 and feed it along the tangent of the first cutting unit 4. It is evident for the skilled person that the feeding may function also without feeding members 42, e.g. by arranging a rough surface at the outer periphery 401 of the discs 40 that provide sufficient friction.

As shown in FIG. 4 the annular knife 41 protrudes a distance T out from the peripheral edge of the discs 40. In a preferred embodiment the distance T is about 5 to 10 mm. The tip portion of the annular knife 41 has a cutting edge 410 formed by a first side 411 of the annular knife 41 and an oblique tip portion, such that the edge 410 is positioned in the same plane as the first side 411. The support surface 300 of the support plate 30 is positioned a desired distance G below a parallel tangential line of the discs 40, such that a gap G is obtained between the peripheral edge 401 of each disc and the support surface 300 of the support plate. The gap G may be as large as the outlet U, but preferably the gap G is smaller than the outlet U, to achieve further compacting. Preferably the gap G is between 3-6 mm. The annular knife 41 will have its cutting edge 410 protruding into the gaps 31 of the support plate 3. The much larger total width of the support surface relative the total width of the cutting knifes 41 assists in providing stripes of appropriate shape.

In order to achieve a good cut of the container there is a small play P, e.g. 0.05- 0.1 mm, between the first side 411 of the annular knife 41 and a first side 310 of each groove 31. On the other side of the annular knife 41 there is a wider play to the side of the groove 31, in the order of about 0.5 to 3 mm. Accordingly the width S of each groove 31 is substantially larger than the width W of the annular knife. In the preferred embodiment the annular knife has a width W of about 2 to 4 mm, and the groove 31 a width S of about 3 to 6 mm. The radius R of the annular knife may vary, but in the preferred embodiment it amounts to about 200 to 300 mm.

At one outer edge of each disc 40 there is an annular recess 402 that is substantially smaller transversally than the corresponding width W of the annular knife 41, such that when the annular discs 40 are fixated to each other the annular knifes 41 will be tightly clamped in between the discs and kept at a radial position defined by the recesses 402. The distance K between each knife 41 I preferably in the range of 15-30 mm, more preferred about 20-25 mm, which according to the preferred design is achieved by using discs having a corresponding width plus the width W of the knife 41 minus the width of the recess 402. Thereby a relatively large support surface 300 may also be obtained.

The rotation of the first knife unit 4 is synchronised with the infeed and compressing unit 2, such that the feeding speed provided by the infeed and compressing unit 2 is the same as the peripheral speed of the central discs 40. An optimal speed corresponds to the feeding of about 0.5-5 containers/s, e.g. 0.15-0.8 m/s. The synchronization may preferably be achieved by using one and the same motor (not shown) and the use of a synchronizing transmission (e.g. dented wheel), as is well known per se.

The support plate 3 is positioned substantially horizontally having a first end adjacent to outlet from the infeed and compressing unit 2, and a far end positioned substantially in line with the vertical centre line through the centre C of the first cutting unit 4.

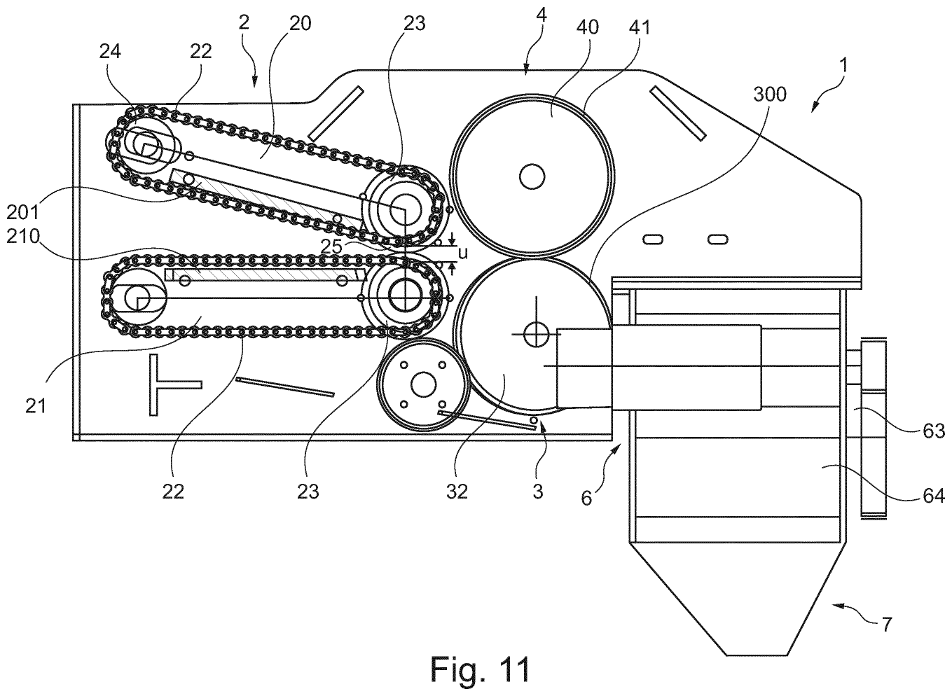

A guide plate 5 may be provided on the opposite side of the vertical line passing through the centre C of the first cutting unit 4. This guide plate 5 has as its object to safeguard that a container 9 that has been cut into stripes by the first cutting unit 4 is safely separated from the first cutting unit 4, to thereafter fall down into a second cutting unit 6. As shown preferably said longish stripes are guided to leave said first cutting arrangement (4) along a substantially horizontal plane, which provides for easy feeding into the second cutting unit 6 thanks to gravity and positioning of the in feed in proximity to the position where the stripes leave the first cutting arrangement 4, especially if a nip is used in the second cutting unit, as shown in FIGS. 11-14.

The guide plate 5 has a similar design as the support plate 3. As shown in FIG. 4 it comprises a plurality of grooves 51, forming fingers 52. The fingers 52 have one side facing the discs 40 arranged with tapering 520 to provide a relatively sharp front end that may be positioned close to the peripheral surface 401 of the disc 40. The fingers 52 that protrude into and between the annular knifes will force the cut container foils to be pushed out from between the knifes 41 and to follow the downwardly oriented surface 501 of the guide plate 5. As a consequence, a container 9 that has been cut along all its length will be pushed out from contact with the first cutting unit 4 by means of the guide plate 5, to thereafter fall into the second cutting unit 6. It is understood that the length of the out pushing unit 5 preferably should be at least as long as the total length of a compressed container 9. Further, there may be arranged a hole 502 in the guide plate 5 to enable supply of air and/or cleaning liquid that may be an advantage to in relation to transportation and/or cleaning.

In an embodiment as shown in FIGS. 7 and 8, where feeding members 42 are arranged on the peripheral surface 401 of the discs 40, there may be two fingers 52 interacting with each disc 40, i.e. also two grooves 51, one groove for the knife 41 and a neighbouring groove 51 for feeding members 42. The feeding members 42 may be in the form of a plurality (10-30/row) of short stubs (protruding 1-4 mm) displaced centrally on each disc 40 in a row.

Further, FIGS. 7 and 8 also shows that in a preferred embodiment the discs 40 are fixedly attached to a hub 431 that is adjustably attached to a central shaft 431, and that adjustment members 450 enables adjustment of the axial position of the hub 431 to enable easy adjustment of the play P between the knifes 41 and the support plate 3.

The second cutting unit 6 comprises of a plurality of cutting discs 60 fixedly attached to a rotating shaft 61 that is driven by a motor 600 via a transmission (not shown) that is connected to the drive end 610 of the shaft 61. A support and bearing unit 611 maintain the shaft 61 in a substantially horizontal position and a sub-housing 612 protects the bearing and support unit 611. The discs 60 are rotated at a relatively high speed, e.g. 500 to 1500 rpm and are positioned at a distance X between each other, such that when the slit container foils fall down from the first cutting unit 4 into the second cutting unit 6 the longish foils will be cut into a plurality of shorter fragments. Preferably the distance X between the discs is in the range of 20 to 40 mm. Thanks to the high speed of the discs 60 the fragments will be cut instantaneously and in between the discs 60 there are arranged guiding plates 65, 62 that guide the fragments to move on to the outlet unit 7. A first guiding plate 65 extends from an upper position attached to the housing 10 at a level above the upper periphery of the discs 60 and obliquely downwardly with a plurality of guiding fingers in between the discs, such that the ends 650 of the guiding fingers terminate at about the horizontal level of the centre of the shaft 61 at an opposite side of the shaft 61 in relation to the attachment position at the housing 10, i.e. to the side where the discs 60 have a downward rotation movement, which will cause the fragments to move downwards into the outlet unit 7. The first guiding plate 65 thereby also hinders fragments to be thrown up by the discs 60 into the first cutting unit 4. Further, the first guiding plate 65 is positioned such there is formed a gap between the shaft 61 and the lower side of the guiding fingers to allow fragments that may follow the rotation of the discs 60 to again move downwards between the shaft and the lower side of the guiding fingers, to a position where the discs 60 are moving downwards. The second guiding plate 62 extends from an upper position basically at the same horizontal starting level as the first guide plate 65 but attached to the opposite side of the housing 10 and protrudes slightly obliquely downwards but generally vertically to a position that is substantially in level with the horizontal centre line passing through the centre of the shaft 61. Accordingly, there will be an opening 66 between the ends 650, 620 of the guiding plates that enables cut fragments to pass through without getting stuck. The angle β of downward extension of the first guiding plate 65 is such that β is larger than the corresponding angle γ of the second guiding plate 62. Preferably β is in the range of 30 to 50° and the corresponding angle for the second guiding plate 62 is in the range of 70 to 90°.

The outlet unit 7 preferably comprises a cone shaped collecting part 70 that at its end interconnects with a transport member 71. Preferably, the transport member 71 is in the form of a tubing or conveyer that is used to transport the fragments away into a storage arrangement 700.

In one embodiment the transport in a tubing is achieved by means of vacuum, e.g. having a vacuum creating unit 701 that causes a sub-pressure in the tubing to pull the fragments into the storage arrangement 700 through 71 and also creates a sub-pressure in the second cutting unit 6 and the collecting part 70. It may be a preferable option to also have supply of water to the handling machine 1 and then preferably supply of water that may assist in cleaning both the first 4 and the second 6 cutting units and that may also assist in transporting the fragments through the tubing 71, e.g. above the positioned above support plate 3 adjacent the inlet into the first cutting unit 4, spraying water onto the compressed containers 9 and into the gap G, to thereafter “automatically” continue into the second cutting unit 6.

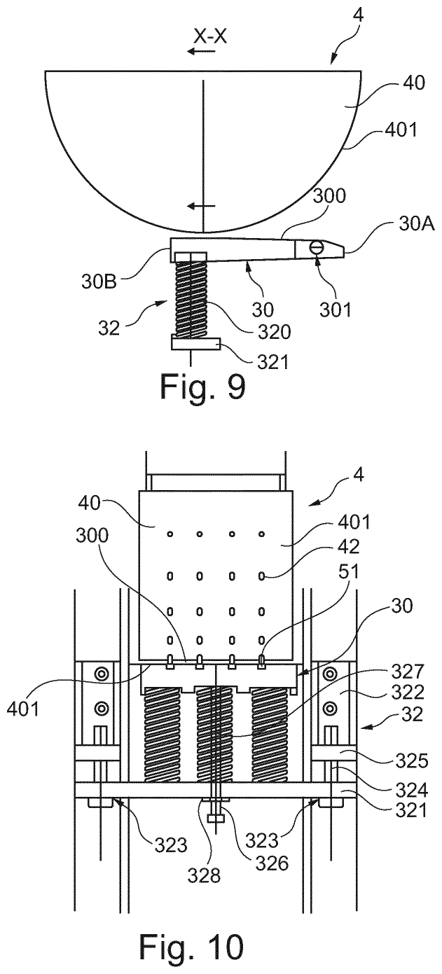

According to a modification of the invention as indicated in FIGS. 9 and 10, the handling machine 1 is merely used for compressing/compacting a container 9, i.e. without any shredding, especially suitable for metal containers. Basically, it is the same kind of apparatus, but without knives in the compacting arrangement 4 and also without any second cutting unit 6.

The modified handling machine also comprises an inlet arrangement 8, which can be in various forms (as is evident for the skilled person). The infeed and compressing arrangement 20, 21 is preferably exactly the same as described above. The subsequent compacting arrangement 4 is basically the same, but without knives and as a consequence a homogenous compacting body 40 may preferably be used, in place of a plurality of discs. The principle of compacting is the same as described above, i.e. the compressing arrangement 20, 21 feeds a container 9 through the outlet 25 having a compression distance U provided to achieve a first stage of compression of the container 9 and also feeds the container into the subsequent compacting arrangement 4. The compacting arrangement 4 achieves a further compression of said container 9, by means of having the compacting body 40 with its outer peripheral, circular surface 401 rotatably arranged about the shaft 43. The outer peripheral, circular surface 401 interacts with the support surface 300 of the support unit 3. The support surface 300 faces the outer peripheral, circular surface 401, and is positioned a compacting distance G from a parallel tangential line of the outer peripheral, circular surface 401, such that a gap is obtained between the outer peripheral, circular surface 401 and the support surface 300, such that the container 9 is further compacted when passing the gap. The compacting distance (G) may be as large as the compression distance (U), but preferably is smaller than said compression distance (U).

Tests have shown that a much more efficient compacting of a container may be achieved according to the invention, than known handling machines of today. In general, known handling machines may achieve compaction of a container to about 9 mm. With a handling machine according to the invention a compaction of a container may be achieved to about 3 mm, implying 3 times better use of space storage of compacted containers.

It is evident that no grooves for knives are required in the modified embodiment regarding the support plate 3 and that therefore the above described intermeshing fingers of the above kind are not required in the guide plate 5. However, other basic design properties may preferably be the same. For example, the support plate 3 is preferably positioned substantially horizontally having a first end adjacent to the outlet 25 from the infeed and compressing unit 2, a far end positioned substantially in line with the vertical centre line through the centre C of the compacting arrangement 4 and grooves 51 for feeding members 42.

As shown in FIGS. 9 and 10 the support plate 30 may preferably be pivotally arranged and urged by means of a resilient force against the periphery of the compacting arrangement 4, which embodiment may also be used in connection with knives. A fixed pivot axis 301 is arranged adjacent a first end 30A (in the direction of movement) of the support plate 30, which first end is adjacent to the outlet 25 of the infeed and compressing unit 2. Adjacent the second end 30B of the support plate 30 there is arranged an urging device 32 that presses the second end 30B in a direction towards the periphery 401 of the compacting arrangement 4. Hereby, a container 9 may be compacted further thanks to the resilient force by the urging device 32 the surface of the support plate to compact in an adaptable manner, i.e. in between the bottom and top portion of a container a higher degree of compaction may be achieved at a certain pressing force than at the bottom and top portion. Hence, an even higher degree of compaction may be achieved when using a pivotal support plate 30 that is movably urged by a compaction force, which preferably is at the level of about 1000-3000 N.

As shown in FIG. 10 the urging device 32 may preferably include on or more springs 320 between a base plate 321 and the support plate 30. The base plate 321 may be adjustably attached to fixed brackets 322 by means of adjustment units 323, e.g. in the form of screws 324 threadedly mounted in baseplate members 325. Hence, the applied force may be adjusted by screwing and unscrewing respectively. Further there may be a stop member 326 arranged to limit the upper position of the support plate 30, i.e. to hinder the surface 300 of the support plate 30 to pivot into contact with the periphery 401 of the compacting arrangement 4. Preferably, stop member 326 is adjustably arranged, e.g. by means of using a rod like member 327 that has a first end rotatably fixed at the support plate 30 and the other, second end protruding a distance out from the base plate 321 and also having a threaded portion adjacent the second end, which threaded portion interacts with a nut device 328 fixed to the base plate 321. Accordingly, a minimum gap between the periphery 401 and the surface 300 of the support plate 30 may be adjusted by screwing and unscrewing the rod like member 327, respectively.

The guide plate 5 is preferably provided for also in this embodiment, on the opposite side of the vertical line passing through the centre C of the compacting arrangement 4. The guide plate 5 has as its object to partly assist in eliminating any substantial curvature of the finally compacted container 9 and also to assist in secure feeding out of a finally compacted container 9, to thereafter fall down into the outlet arrangement 7. If feeding members 42 are arranged on the peripheral surface 401 of the compacting body 40, there may be grooves 51 in the guide plate 5 for feeding the members 42, forming small fingers 52 having one side facing the compacting body 40 arranged with tapering 520 to provide a relatively sharp front end that may be positioned close to the peripheral surface 401 of the compacting body 40.

In FIGS. 11, 12, 13 and 14 there is shown a preferred embodiment of a compacting and cutting machine 1 according to the invention.

Basically, many of the same principles apply for this preferred embodiment as the principles used in connection with the embodiment shown and described in relation to FIGS. 1,2, etc. The same reference numerals have been used for features that provide the same kind of function as in the first embodiment. The description of the preferred embodiment according to FIGS. 11-14 will therefor mostly be focused on features that differ from what is shown in relation to the first embodiment.

A major difference is that the support device 3, in the first compacting and cutting unit 4 is in the form of a roll 32, that rotates to also assist in urging the container 9 through the gap between the two rolls 40, 32. A further major difference is that basically exactly the same setup of rolls 63,64 are used in a second cutting/shredding step, as the rolls 40, 32 used in the first compacting and cutting step. The second cutting and slicing unit 63, 64 is positioned transversely in relation to the first cutting and cutting and compacting unit 4, such that strips from the first cutting and compacting unit 4 will fall in to the second unit 63, 64 in parallel with the gap/nip between the rolls 63, 64 second unit 6, which will provide for more or less automatic infeed of the strips from the first unit 4 in to the second unit 6.

As shown in FIG. 11, the infeed unit 2 is basically the same as shown in FIG. 1. However, in order to further assist in compacting the containers there are support and guiding plates 201, 210 that will assist in keeping the chains 22 along the intended V shaped compaction gap, which may improve reliability to enable feeding of a container through the gap U and then further in to the nip between the two rolls 40, 32 in the first compacting and cutting unit 4. The support and guiding plates 201, 210 are preferably arranged with longitudinal grooves (not shown), one for each chain, that will support the chains not only in relation to the compression pressure from a can 9 but also keep the chains in parallel along their intended route of travel from the end wheel 24 to the driving wheel 23. In the preferred embodiment such a groove is designed to support the rolls of each chain 22, which enables relatively friction free interaction between the chains 22 and the support plates 201, 210.

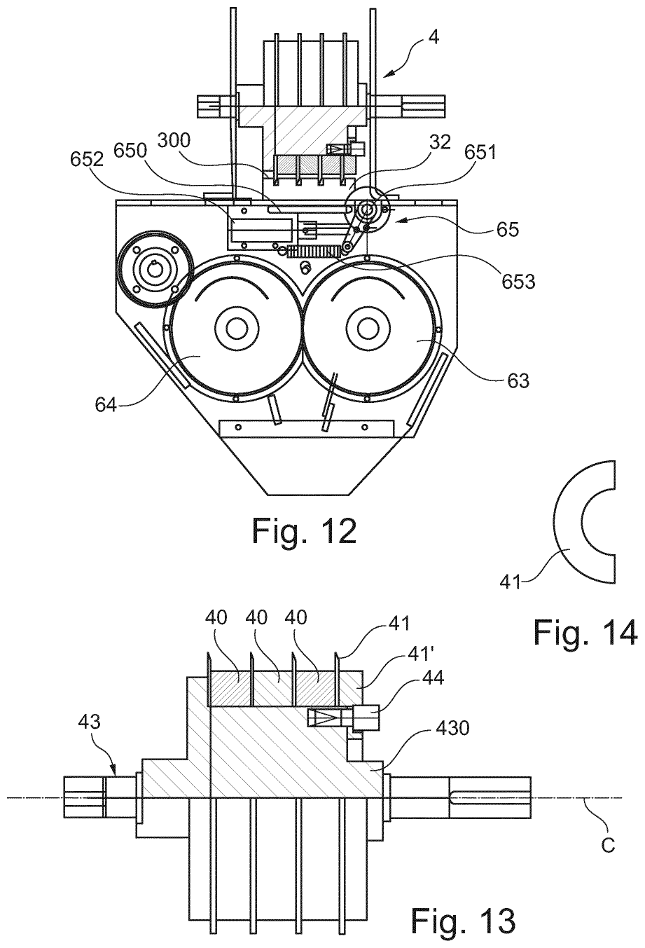

In FIG. 12 there is shown a side view of the embodiment shown in FIG. 11, wherein an upper part of the upper roll 40 has been shown in a cross section. As can be noted the support roll 32, provided with the support surface 300 is also arranged with circumferential grooves 31, fulfilling the same function as the slots 31 used in connection with the first embodiment, i.e. providing space for the knife blades 41 to protrude past the support surface 300.

Further, FIG. 12 shows that there may be provided a specific buffer mechanism 65 that provides for keeping a horizontal buffer of the stripes delivered from the first cutting arrangement before they are introduced into the second cutting unit 6, in order to improve control that the stripes are introduced horizontally into the nip of the second cutting unit 6, which is advantageous. The buffer mechanism 65, comprises a pivotable plate 650 that may pivot from a horizontal position (as shown in FIG. 12) to an angled position (e.g. about 50-60°) about a pivot axis 651. An actuator 652 (e.g. electro-magnetic plunger) is used to move the pivotable plate 650 into its angled position and a spring 652 may be used for returning it. The process is controlled by some sensor device (not shown, e.g. optic) that will initiate actuation of the actuator 652 at a time coinciding with stripes having landed on the pivotable plate 650.

In FIG. 13 it is shown in more detail that the knife blades 41 are clamped in to position by means of compression screws 44 that urge a compression disc 41′ to fixate each one of the knife blades 41 between neighboring discs 40. The plurality of compression screws 44 are threadedly connected to a shaft body 430 which is arranged with an outer surface 431 that is adapted to the inner radius r of the knife blades 41. The shaft body 430 may form an integral part with the shaft 43.

As can be seen in FIG. 14 the knife blades 41 are preferably in the form of half circles which provides for the advantage that the knife blades 41 may easily be exchanged without disassembly of the roll 40. It is merely needed to untighten the compression screws 44 to allow for the friction and clamping force between the discs 40 and the knife blades 41 to loosen and thereafter each knife blade half 41 may be easily taken out of its position and replaced.

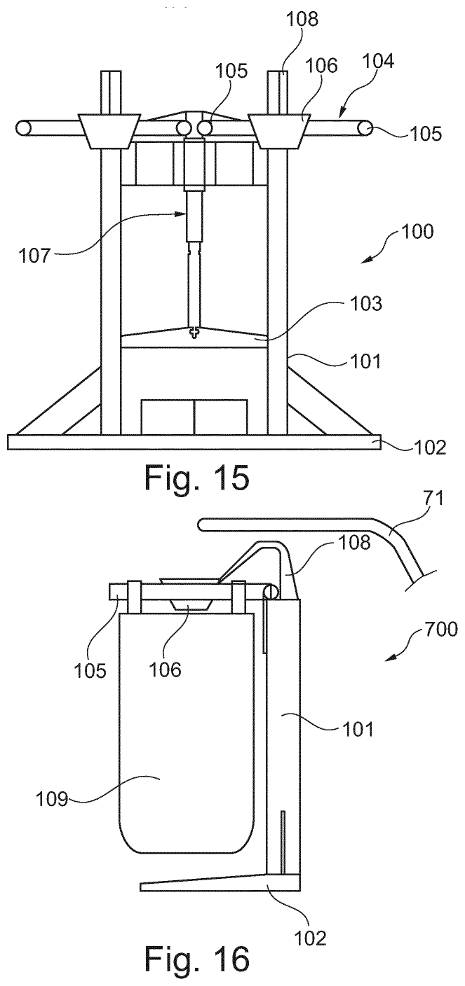

In FIGS. 15 and 16 there is shown a preferred storage arrangement 700 for collection, storage and transport of compacted material, e.g. shredded pieces of plastic and metal respectively. There is shown a stand comprising a base 102 and two vertical frame members 101 protruding from said base 102. Adjacent to the base 102 there is a cross bar 103 that extends between the two vertical support members 101. Along the vertical support members 101 at the upper part thereof there is arranged a moveable holder arrangement 104. The moveable holder arrangement 104 includes a plurality of substantially horizontal rods 105. The holder rods 105 enable positioning of a storage bag 109 to be supported by a pair of said holding rods 105. Preferably there is more than one pair of holding rods 105, e.g. one pair for a first bag and a second pair for a second bag, which provides the advantage that there may be separate bags for plastic and metal respectively that can be used together with a shredding machine handling both materials. A drive unit 107 is arranged with one end connected to the cross bar 103 and another end attached to the movable holding device 104. Thereby the moveable member 104 may be moved up and down, i.e. vertically, by means of the drive member 107.

Centrally between each pair of holding rods 105 there is a funnel 106 enabling more reliable feed supply of shred into the bags. Preferably, as indicated in FIG. 16, the transport member 71 is in the form of a conveyer that is used to transport the fragments into the funnel 106. The conveyer 71 may be driven intermittently, which provides the advantage that an appropriate time lag may be achieved to change a bag, i.e. by first emptying all shreds on the conveyer 71 and then resume intermittent drive thereof, enabling the machine 1 to continue producing shred during bag change. Either, the storage arrangement 700 or the conveyer end may be movable, to change from feeding into one bag or the other.

Thanks to the storage arrangement 700 it is feasible to achieve further compaction of the shredding, especially beneficial in combination with bags, by means of using the driving unit 107 to move the bag up and down and to bounce into the ground, whereupon the shredding will be effectively further compacted in the bag and/or by delivering vibrations by means of the driving unit 107 or a separate vibration proving means (not shown). Preferably the bags 109 are positioned on top of pallets to facilitate easy transportation of a filled bag. Once a filled bag is to be taken away the driving unit 107 is first moved downwards to loosen the connection of the bag to the holding rods 105.

A preferred embodiment of bags 109 may provide a storage space of more than 1 m³, e.g. 1.3 m³ that may contain around 800 to 1000 kg of alumina shred, which according to traditional handling of recycled cans would amount to 13 m^{3.} Hence, enormous saving may be achieved by the inventive concept, merely needing 1/10 of storage and transport space compared with traditional handling.

The invention is not limited to the above description but may be varied within the scope of the appending claims. For instance, it is realized that the support device 3 used may vary, e.g. be combined with a first kind in the cutting arrangement 4 and a second kind in a second cutting unit 6. Further it is realized that some of the features described above may be used in combination with other devices, e.g. known prior art devices, and as consequence it is foreseen that some of the features may be subject for their own protection by means of filing divisional applications, e.g. the storage arrangement 700, the infeed and compacting unit 2, etc. Further, it is foreseen that the invention may fulfill its purpose producing stripes also without having any recess in the support device 3 for interaction with the knife edge 410, e.g. by adjusting the rolls such that there is no gap at all, or providing softer material (annular rings or discs, e.g. rubber) for interaction with the knife edges.

1-17. (canceled)

18. A handling machine for containers, comprising:
an inlet arrangement,
an infeed and compressing arrangement,
a cutting arrangement, and
an outlet arrangement, wherein empty containers are handled to at least partly be provided in shredded form in the outlet arrangement, wherein said infeed and compressing arrangement is arranged to both compact and forcibly urge a container into said cutting arrangement, which cutting arrangement comprises a cutting roll interacting with an oppositely positioned support surface of a support device, wherein said cutting roll includes a plurality of parallelly arranged knife blades having sharp annular cutting edges arranged to cut through said container by counter action with said support surface.

19. The handling machine according to claim 18, wherein said sharp annular cutting edges protrude into adapted passages of said support surface.

20. The handling machine according to claim 18, wherein a second cutting unit is arranged to cut transversally in relation to said first cutting unit, wherein preferably said cutting arrangement is arranged to feed out cut stripes in a horizontal plane and said second cutting unit is arranged to feed out shredded pieces in a vertical plane, and more preferred wherein said second cutting unit is of the same kind as said cutting arrangement.

21. The handling machine according to claim 18, wherein said support device is a roll, wherein said adapted passages are in the form of circumferential grooves.

22. The handling machine according to claim 18, wherein a plurality of said knife blades are in annular form, having a thickness in the range 0.5-5 mm, preferably 2-4 mm, and clamped into position between two adjacent circular discs.

23. The shredding machine according to claim 20, wherein each knife is divided into a plurality of parts, preferably in the form of two semi-circular parts.

24. The handling machine according to claim 21, wherein there is arranged a guide plate provided with a plurality of fingers in between the knife blades, arranged to guide cut stripes out of said first cutting arrangement.

25. The handling machine according to claim 18, wherein said in-feed and compressing arrangement is arranged to feed a container with one of its ends to first get in contact with and into said first cutting arrangement.

26. The handling machine according to any of claim 18, wherein said in-feed and compressing arrangement comprises two conveyor devices arranged with a relatively large inlet and a relatively small outlet.

27. The handling machine according to claim 24, wherein said conveyor devices are in the form of chain conveyors, comprising a plurality of parallel rows of chains.

28. The handling machine according to claim 25, wherein said guiding plates are arranged in contact with said chains arranged to control feeding and compression of the containers, wherein preferably guide grooves are arranged for a plurality of said chains.

29. A method for handling of containers, comprising the steps of:
a. supplying a container by means of an inlet arrangement to an infeed and compression arrangement,
b. compressing and feeding said container infeed and compression arrangement,
c. feeding said container by means of said infeed and compression unit into a cutting arrangement, including a cutting roll having a plurality of parallelly arranged cutting devices having annular cutting edges, and
d. cutting said container by means of said cutting arrangement into longish stripes, wherein using said infeed and compressing arrangement to both compact and forcibly urge said container into said cutting arrangement, and by having said cutting devices including knife blades interacting with an oppositely positioned support surface of a support devices.

30. The method according to claim 29, further comprising having passages arranged to enable protrusion of said annular cutting edges.

31. The method according to claim 29, further comprising guiding said longish stripes out of said first cutting arrangement by means of a guide plate, wherein preferably said longish stripes are guided to leave said first cutting arrangement along a substantially horizontal plane.

32. The method according to claim 29, further comprising
e. feeding said longish stripes into a second cutting unit,
f. cutting said longish stripes transversally by means of said second cutting unit into a plurality of smaller parts, preferably to leave said second cutting unit along a substantially vertical plane, and
g. transporting said smaller parts by means of an outlet arrangement to a storage arrangement.

33. The method according to claim 29, wherein said storage arrangement includes at least one, preferably a plurality of, bag/s carried on movable holding rods being movably arranged by means of a driving unit, wherein preferably said storage arrangement includes use of said driving unit to compacting material in said bag/s.

34. The method according to claim 29, wherein said in-feed and compressing arrangement is arranged to feed a container with one of its ends to first get in contact with and into said first cutting arrangement.
